(19) United States
(12) Patent Application Publication
(10) Pub. No.: US 2005/0159171 A1
(43) Pub. Date: Jul. 21, 2005

(54) Mobile communication system, mobile communication terminal, and mobile communication method

(75) Inventor: Takahiro Kaneko, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation

(21) Appl. No.: 11/038,363

(22) Filed: Jan. 21, 2005

(30) Foreign Application Priority Data
Jan. 21, 2004 (JP) 12544/2004

(51) Int. Cl. H04Q 7/20

(52) U.S. Cl. 455/456.1; 455/423; 455/452.1

(57) ABSTRACT

A mobile communication system provides a radio base station, a mobile communication terminal and a radio control station. The radio base station communicates with a mobile communication terminal within a service area. When the mobile communication terminal cannot communicate with the radio base station, the mobile communication terminal measures a present position by means of Global Positioning System and stores the present position. The radio control station receives the present position from the mobile communication terminal. A service provider managing the system can determine an area where the service provider cannot provide communication service based on the position.

### BACKGROUND OF THE INVENTION

1. Field of the Invention

The present invention relates to a mobile communication system, a mobile communication terminal and a mobile communication method, in particular, to a technology in which the mobile communication terminal determines an area where service is available.

2. Description of the Related Art

In a mobile communication system, there resides an area where a mobile communication terminal cannot ensure a satisfactory reception electric field level for carrying out communication, that is, an area where a user of the mobile communication terminal cannot enjoy service (that is, an out of service area). When the mobile communication terminal is positioned in such an area, the mobile communication terminal displays information indicating the fact that the service is not available in the area. For example, Japanese Unexamined Patent Application Publication No. 2002-186045, Japanese Unexamined Patent Application Publication No. 2003-161622, and Japanese Unexamined Patent Application Publication No. 2003-284137 disclose technologies which are utilized when a mobile communication terminal cannot obtain a satisfactory reception electric field level.

It is necessary for a service provider that provides mobile wireless communication service to determine the area where users of mobile communication terminals cannot receive the service. As well known methods to determine such an area, a method, which utilizes a simulation, and a method, in which an actual reception electric field level is measured in the concerned area, are available. However, it is difficult to determine the area in detail with the simulation. Also, a considerable man-hour is required to actually measure the reception electric field level.

### SUMMARY OF THE INVENTION

A mobile communication system according to the present invention provides a radio base station, a mobile communication terminal and a radio control station. The radio base station communicates with a mobile communication terminal within a service area thereof. When the communication with the radio base station is in bad condition, the mobile communication terminal measures and stores a present position. The radio control station receives the present position from the mobile communication terminal.

The mobile communication terminal of the present invention comprises a measuring device for measuring the present position and a memory for storing the measured position. When the communication with the radio base station is in bad condition, the mobile communication terminal measures the present position.

A mobile communication method of the present invention comprises the following steps. That is, the mobile communication method provides, when the mobile communication terminal cannot carry out the communication with the radio base station, a step for measuring a present position of the mobile communication terminal, a step for storing the measured present position in the mobile communication terminal and a step for transmitting the present position from the mobile communication terminal to the radio control station via the radio base station. In the above-described invention, the mobile communication terminal can transmit the information of the present position in response to a request from the radio control station.

A computer program according to the present invention is a program by which the mobile communication terminal transmits a present position of its own terminal to the radio control station, which makes the computer within the mobile communication terminal execute the following processing. That is, when a received signal from the radio base station is equal to a predetermined level or less, a processing for measuring a present position of the mobile communication terminal, and a processing for storing the present position in the mobile communication terminal are executed, and when the received signal from the radio base station is larger than the predetermined level, a processing for transmitting the position to the radio control station via the radio base station.

Owing to the above-described invention, it is possible for a service provider of the mobile communication system to readily determine such an area that a mobile communication terminal cannot carry out communication, that is, an area where communication service cannot be provided.

### BRIEF DESCRIPTION OF THE DRAWINGS

The above and other objects, features and advantages of the present invention will become apparent from the following detailed description when taken with the accompanying drawings in which:

FIG. 1 is a block diagram of a mobile communication terminal according to an embodiment of the present invention;

FIG. 2 is a block diagram of a mobile communication system according to the embodiment of the present invention;

FIG. 3 shows an example of operation of the mobile communication terminal; and

FIG. 4 shows another example of operation of the mobile communication terminal.

### DETAILED DESCRIPTION OF THE PREFERRED EMBODIMENTS

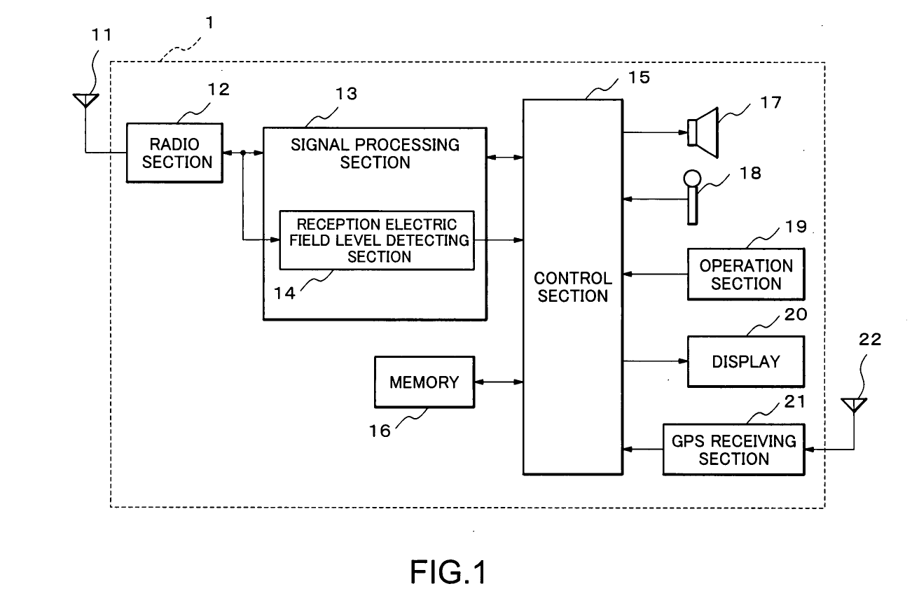

A preferred embodiment of the present invention will be described below. Referring to FIG. 1, a mobile communication terminal 1 of the embodiment is, for example, a cellular telephone. The mobile communication terminal 1 includes an antenna 11, a radio section 12, a signal processing section 13, a reception electric field level detecting section 14, a control section 15, a memory 16, a speaker 17, a microphone 18, an operation section 19, a display 20, a Global Positioning System (GPS) receiving section 21 and a GPS antenna 22. The signal processing section 13 performs modulation/demodulation processing of digital signals on the data to be transmitted to a radio base station and received from the radio base station. The reception electric field level detecting section 14 is disposed in the signal processing section 13. The reception electric field level detecting section 14 detects a reception electric field level of radio signals transmitted from the radio base station, and notifies the detected result to the control section 15. The operation section 19 is a key input section and provides operation keys (not shown) such as a power ON/OFF key, keys for inputting a telephone number, a call start/termination key and input keys for data communication. The display 20 displays an indication of an out of service area/a service area, a reception electric field level, date, time, an operating message, a status of battery and the like. When the electric field level of the received signals detected by the reception electric field level detecting section 14 is equal to a predetermined threshold or less, the GPS receiving section 21 receives GPS signals via the GPS antenna 22, and synchronizes the received GPS signals, and demodulates the data, and calculates a present position of the terminal 1. It is possible to adapt the control section 15 to calculate the present position. The memory 16 stores the calculated present position as positional information, and is further capable of storing a program, data and the like, which are executed by the control section 15.

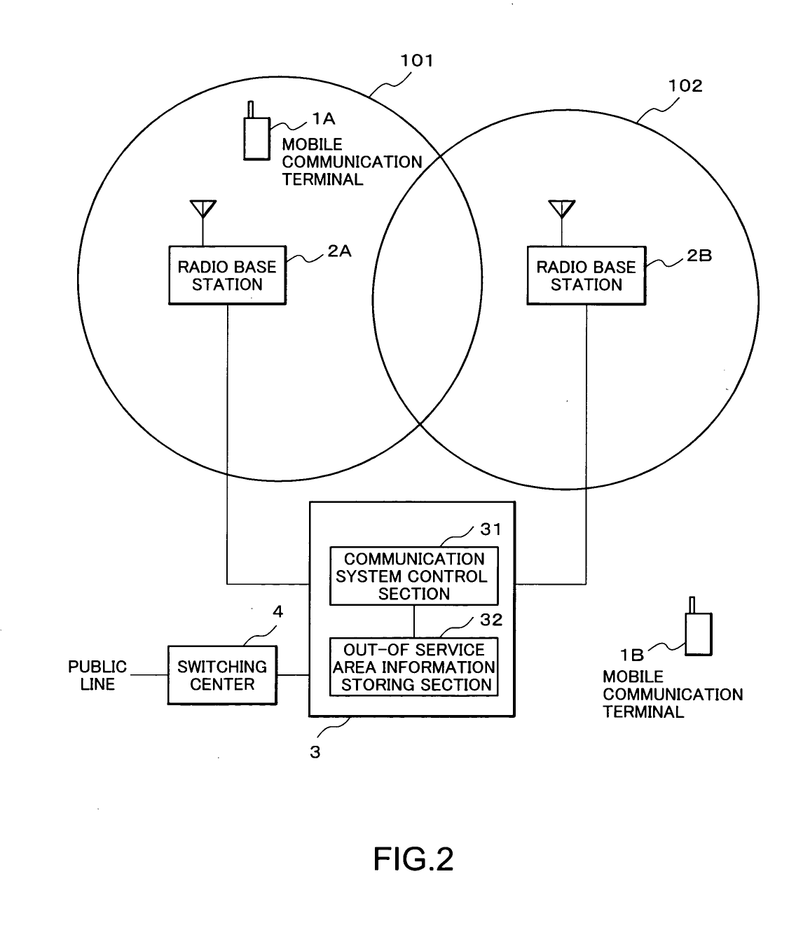

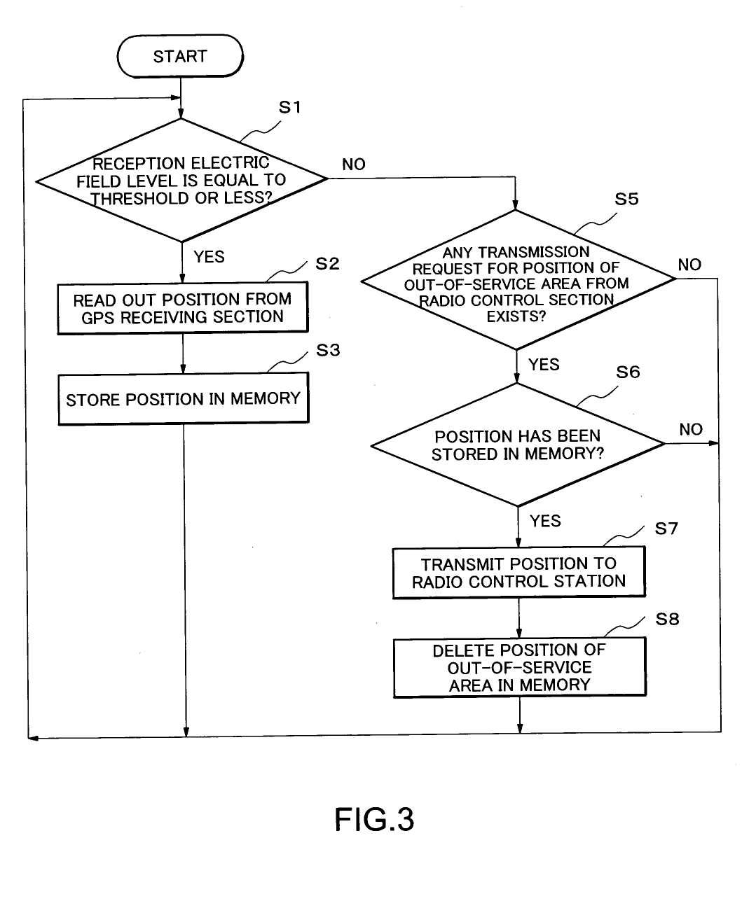

FIG. 2 shows an embodiment of a mobile communication system. FIG. 2 shows radio base stations 2A and 2B, mobile communication terminals 1A and 1B, a radio control station 3 and a switching center 4. The radio base station 2A has a mobile communication service area 101, and the radio base station 2B has a mobile communication service area 102. The radio control station 3 provides a communication system control section 31 and an out of service area information storing section 32. The communication system control section 31 controls the communication in a plurality of service areas. The out of service area information storing section 32 stores the information about the position at which the mobile communication terminal was positioned when the communication with the radio base station was unavailable. The radio control station 3 is connected to a public line via the switching center 4. When the mobile communication terminals 1A and 1B are positioned within the service area 101 or 102, the terminals 1A and 1B can carry out communication with the radio base station 2A or 2B. In FIG. 2, the mobile communication terminal 1A is positioned in the service area 101, and is accordingly possible to carry out the communication with the radio base station 2A. Since the mobile communication terminal 1B is positioned in neither the service area 101 nor 102, the mobile communication terminal 1B is impossible to carry out communication with neither the radio base station 2A nor 2B. The mobile communication terminal 1B measures the position at which the terminal 1B itself is positioned, and stores the information. The radio control station 3 determines the area where the mobile communication service cannot be provided, by collecting such positions or positional information. Referring to FIG. 3, the operation of the mobile communication terminal 1 is carried out, when the control section 15 executes the program in the memory 16. The reception electric field level detecting section 14 in the mobile communication terminal 1 receives radio signals from the radio base station, and detects the electric field level thereof, and notifies the detected result to the control section 15. The control section 15 compares the reception electric field level with a predetermined threshold (S1). When the reception electric field level is equal to the threshold or less (YES at S1), the control section 15 reads out the present position of the terminal 1 obtained by the GPS receiving section 21 (S2), and stores the present position (that is, positional information) in the memory 16 (S3). At this time, the control section 15 can compare the positional information read out at the S2 with the positional information being stored in the memory 16. When these compared positional information is the same (a range to be determined as the same is settable beforehand), the read out positional information may be discarded, or may be overwritten on the same positional information in the memory. When the reception electric field level is larger than the threshold (NO at S1), the control section 15 judges whether any transmission request for positional information from the radio control station 3 exists or not (S5). When a transmission request for positional information from the radio control station 3 exists (YES at S5), the control section 15 judges whether the positional information has been stored in the memory 16 or not (S6). When no transmission request exists (NO at S5), the operation at the step S1 is carried out. When the positional information has been stored in the memory 16 (YES at S6), the control section 15 transmits the positional information to the radio base station (S7). The positional information is transmitted to the radio control station 3 via the radio base station and is stored in the out of service area information storing section 32. When the positional information is transmitted to the radio control station 3, the control section 15 deletes the positional information being stored in the memory 16 (S8). When the memory 16 does not store the positional information (NO at S6), the operation at S1 starts. When the operation at S3 or S8 has completed, the operation starts from S1.

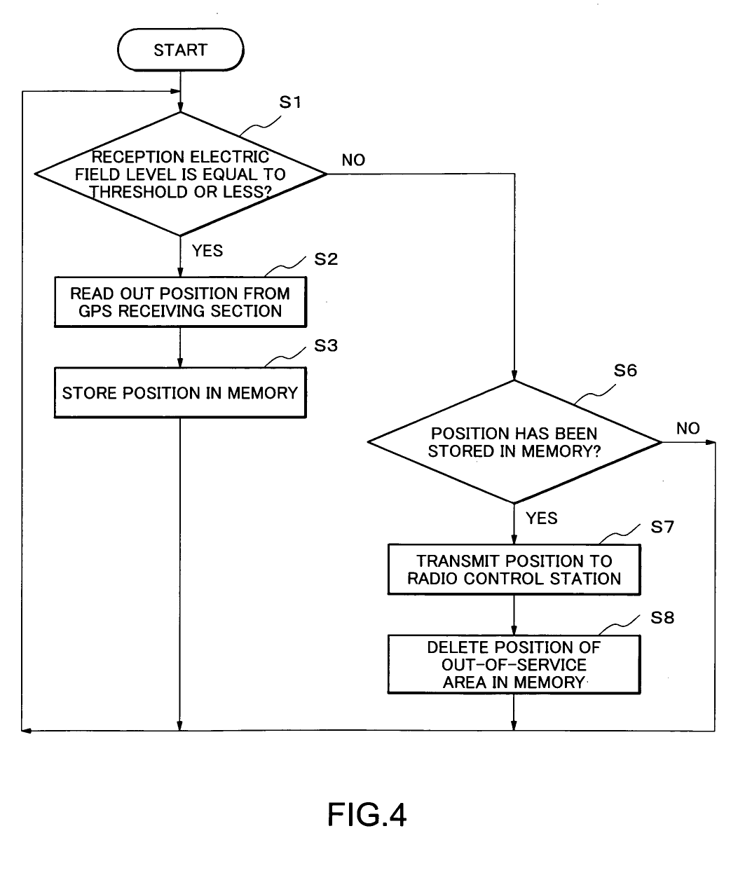

Referring to FIG. 4, another embodiment of the mobile communication terminal is shown. This example is basically the same as the example shown in FIG. 3. However, when it is judged that the reception electric field level is larger than the threshold (NO at S1), the mobile communication terminal 1 immediately judges whether the positional information has been stored in the memory 16 or not (S6). The radio control station 3 can obtain the positional information without transmitting any positional information transmission request.

In many cases, the mobile communication terminal 1 ordinarily measures the reception electric field level at a cycle of approximately 1 to 5 seconds. Also, in the case where a period while the mobile communication terminal 1 is positioned out of the service area becomes longer, the above-described cycle becomes much longer. Every time when the reception electric field level is measured, the mobile communication terminal 1 can carry out the above-described operation of S2 and S5 (in the case of FIG. 3), or the operation of S6 (in the case of FIG. 4). On the other hand, the mobile communication terminal 1 can carry out the above operation every time when the reception electric field level is measured by predetermined times.

According to the present invention, it is possible for a service provider of the mobile communication system to easily determine and update the area, where the communication service is unavailable, based on the received positional information.

While the present invention has been described in connection with certain preferred embodiments, it is to be understood that the subject matter encompassed by the present invention is not limited to those specific embodiments. On the contrary, it is intended to include all alternatives, modifications, equivalents as can be included within the spirit and scope of the following claims.

1. A mobile communication system, comprising:
a radio base station for communicating with a mobile communication terminal in a service area;
a mobile communication terminal that, in the case where communication with the radio base station is in bad condition, measures and stores a present position; and
a radio control station for receiving the present position from the mobile communication terminal.

2. The mobile communication system according to claim 1, wherein the radio control station communicates with the mobile communication terminal via the radio base station.

3. The mobile communication system according to claim 1, wherein the mobile communication terminal transmits the present position, when communication with the radio base station is possible.

4. The mobile communication system according to claim 3, wherein the mobile communication terminal transmits the present position in response to a request from the radio control station.

5. The mobile communication system according to claim 1, wherein the radio control station stores the present position as a position out of the service area.

6. The mobile communication system according to claim 1, wherein the mobile communication terminal measures the present position based on Global Positioning System.

7. The mobile communication system according to claim 1, wherein, in the case where the measured present position is the same as a position stored in the mobile communication terminal, the measured present position is discarded.

8. The mobile communication system according to claim 1, wherein the present position stored in the mobile communication terminal is deleted after being transmitted to the radio control station.

9. A mobile communication terminal, comprising:
a measuring device for measuring a present position; and
a memory for storing the measured present position, wherein,
the mobile communication terminal measures the present position, in the case where the communication with the radio base station is in bad condition.

10. The mobile communication terminal according to claim 9, wherein
the stored present position is transmitted to the radio control station via the radio base station.

11. The mobile communication terminal according to claim 9, wherein
the stored present position is transmitted to the radio control station in response to a request of the radio control station.

12. The mobile communication terminal according to claim 9, wherein
the measuring device measures the present position of the mobile communication terminal by means of Global Positioning System.

13. The mobile communication terminal according to claim 9, wherein,
in the case where the measured present position is the same as a position stored in the memory, the measured present position is discarded.

14. The mobile communication terminal according to claim 9, wherein
the present position in the memory is deleted after being transmitted to the radio control station.

15. A mobile communication method, comprising the steps of:
measuring a present position of a mobile communication terminal when the mobile communication terminal cannot communicate with a radio base station, and
storing the measured present position in the mobile communication terminal, and
transmitting the present position to a radio control station from the mobile communication terminal via the radio base station.

16. The mobile communication method according to claim 15, wherein
the mobile communication terminal transmits the present position to the radio control station in response to a request from the radio control station.

17. The mobile communication method according to claim 15, wherein
the mobile communication terminal measures the present position thereof by means of Global Positioning System.

18. The mobile communication method according to claim 15, further comprising the step of:
storing the present position as a position out of a service area in the radio control station.

19. The mobile communication method according to claim 15, wherein,
in the case where the measured present position is the same as a position stored in the mobile communication terminal, the measured position is discarded.

20. The mobile communication method according to claim 15, further comprising the step of:
deleting the present position in the mobile communication terminal after the present position is transmitted to the radio control station.

21. A program by which a mobile communication terminal transmits a position of its own terminal to a radio control station, wherein the program makes a computer in the mobile communication terminal execute the processing of:
in the case where a received signal from a radio base station is equal to a predetermined level or less,
measuring a present position of the mobile communication terminal; and
storing the present position in the mobile communication terminal,
transmitting the present position to the radio control station via the radio base station in the case where the received signal from the radio base station is larger than a predetermined level.
